(19) United States
(12) Patent Application Publication
(10) Pub. No.: US 2017/0081082 A1
(43) Pub. Date: Mar. 23, 2017

(54) Beverage Carrier

(71) Applicant: Daniel J. Murphy, Herriman, UT (US)

(72) Inventor: Daniel J. Murphy, Herriman, UT (US)

(21) Appl. No.: 15/248,855

(22) Filed: Aug. 26, 2016

Related U.S. Application Data
(60) Provisional application No. 62/211,599, filed on Aug. 28, 2015.

(51) Int. Cl. B65D 25/24; F16M 13/02; B60N 3/10; B65D 51/26; B65D 81/38

(52) U.S. Cl. CPC B65D 25/24; B65D 51/26; B65D 81/3813; B60N 3/10; F16M 13/02

(57) ABSTRACT

A beverage carrier is disclosed which holds a plurality of beverages in a manner that keeps them level while carried in a vehicle. A detachable car seat leveler is used as a block to keep the carrier level during portage. Many types of levelers may be utilized. A secondary storage compartment is also provided which may be used for foodstuffs and utensils. The main beverage storage compartment is ideally insulated so as to reduce heat exchange.

### CROSS-REFERENCES TO RELATED APPLICATION

This Application claims priority as a non-provisional perfection of prior filed U.S. Provisional Application No. 62/211,599 filed Aug. 28, 2015, and incorporates the same by reference in its entirety herein.

### FIELD OF THE INVENTION

The present invention relates to the field of portage and more particularly relates to a carrier for beverages.

### BACKGROUND OF THE INVENTION

The portage of liquids has always been problematic. Since liquids by definition lack a structure which will not be deformed by gravity or other forces, containers have to be used to carry liquids. Such containers have been designed and developed for millennia, and include drinking vessels. Ideal drinking vessels, like cups, are found in many shapes but all carry and contain a suitable volume of beverage for consumption and also feature a means for transporting the vessel, and contained liquid, for drinking. However, most drinking vessels are designed for single person use. This usually does not present a problem if an individual is carrying a drink for himself, or even if he is carrying a second for another individual. However, when an individual is carrying drinks for three or more people, or has some need to carry other objects, or has some other reason that hands cannot be used, beverage portage can become very difficult. The difficulty of beverage portage is further compounded if an individual

has to drive from one location to another. This is a common practice in many office settings where an individual may be designated to make a “coffee run” or will in some way leave a premises to get food and drink for co-workers. Some establishments also deliver food and beverage to customer locations. Loose cups tend to not remain stable in a vehicle as their center of gravity tends to be too high for the base of the cup. Cup holders alleviate this problem by providing a support wall for a cup, but most modern vehicles have a limited number of cup holders scattered throughout the vehicle. Beverage carriers may be employed, as these tend to provide stability to a cup by broadening the base on which a cup is supported and providing some form of side support to prevent tipping. However, prior art beverage carriers are limited in the number of cups that may carry, typically four. Beverages are also carried in these devices in close proximity to each other, which may be problematic when a mixture of cold and hot drinks are carried. Greater temperature differentials result in a faster rate of heat exchange, so when a hot and cold beverage are placed next to each other, they will exchange heat at a faster rate than with air alone. The prior art beverage carriers also do not account for slope in a car seat, forcing it to be placed on the floor or risking tipping of beverages, leading to spillage. Beverage containers also tend to be dedicated to only carrying beverages, other items such as food stuffs must be separately carried.

The present invention may be represented by a carrier for beverages which includes a multitude of cup holders, coupled with a compartment for food stuffs or other items. It also may have a support designed to comport with most car seats. This support may then be removable, thus allowing for some customization for individual cars with different supports and also for the simple presentation of beverages on a flat surface, such as a table. A beverage carrier may also have greater space between beverages and may also feature hot and cold zones to assist in maintaining beverage temperature.

The present invention represents a departure from the prior art in that the beverage of the present invention allows for a larger number of beverages to be carried individually, with greater space between beverages. It also allows for the portage of other items

### SUMMARY OF THE INVENTION

In view of the foregoing disadvantages inherent in the known types of beverage carriers, a new beverage carrier may feature a larger capacity with extra capacity for other items, a modular car seat support and greater thermal control. As such, the present invention's general purpose is to provide a new and improved beverage carrier that is adapted to larger scale beverage and food portage.

To accomplish these objectives, a beverage carrier may comprise a larger capacity box with a larger number of cup holders which are spaced apart to lessen thermal exchange. The box then would have storage space for food stuffs and possibly other items such as hot or cold packs to assist in maintaining the thermal integrity of the beverages. Its underside may have an attachment structure for a modular car seat support. The support then could be a generally angled block to comport with most car seat shapes. The support may also be a stack of blocks secured together in a manner to allow for customization of the support height. Either support would allow the beverage carrier to be placed on a passenger seat next to a driver and still maintain a level orientation and prevent spillage. The support should be easily removed so that the beverage carrier may be placed upon a table for service or for the utilization of a different support for a different vehicle.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a partially open front elevation of a beverage carrier depicting one embodiment of the invention, with the seat leveler module removed.

FIG. 2 is a partially open front elevation of the beverage carrier of FIG. 1, with the seat leveler installed.

FIG. 3 is a side elevation of the beverage carrier of FIG. 1.

FIG. 4 is a rear elevation of the beverage carrier of FIG. 1.

FIG. 5 is a top plan view of the beverage carrier of FIG. 1.

FIG. 6 is a bottom plan view of the beverage carrier of FIG. 1.

FIG. 7 is a side elevation of a car seat leveler which may be used with the beverage carrier of FIG. 1.

FIG. 8 is a top plan view of the car seat leveler of FIG. 7.

FIG. 9 is a perspective view of the beverage carrier of FIG. 1 in use in a vehicle.

FIG. 10 is a transparent perspective view of the beverage carrier of FIG, 1 with an alternate car seat leveler.

FIG. 11 is a side elevation of the car seat leveler of FIG. 10, disassembled.

### DETAILED DESCRIPTION OF THE PREFERRED EMBODIMENT

With reference now to the drawings, the preferred embodiment of a preferred embodiment beverage carrier is herein described. It should be noted that the articles “a”, “an”, and “the”, as used in this specification, include plural referents unless the content clearly dictates otherwise.

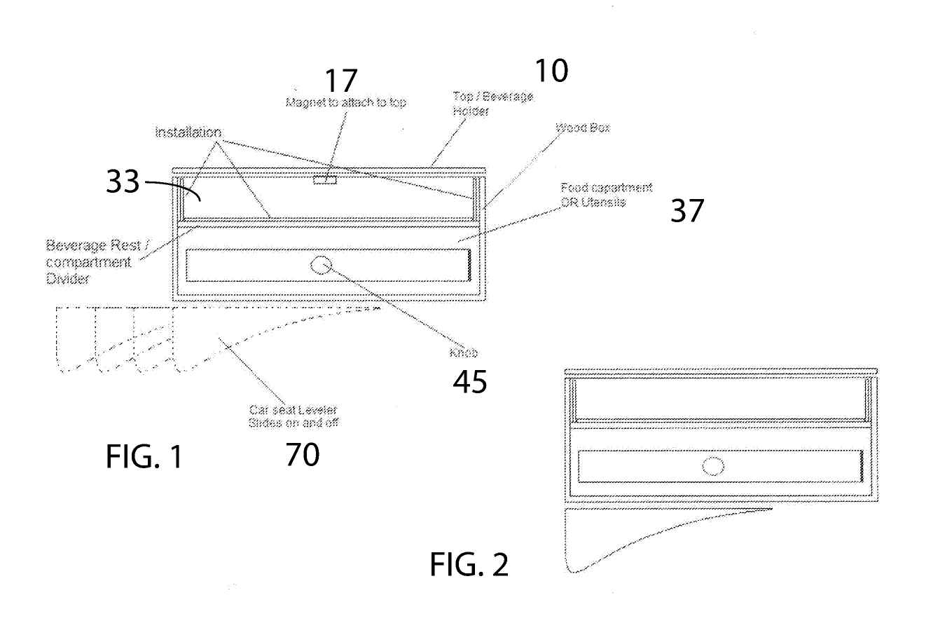

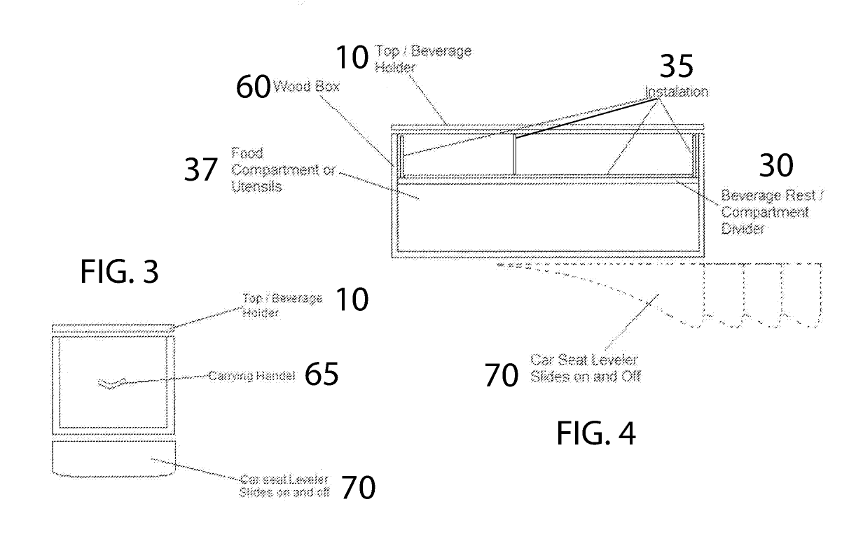

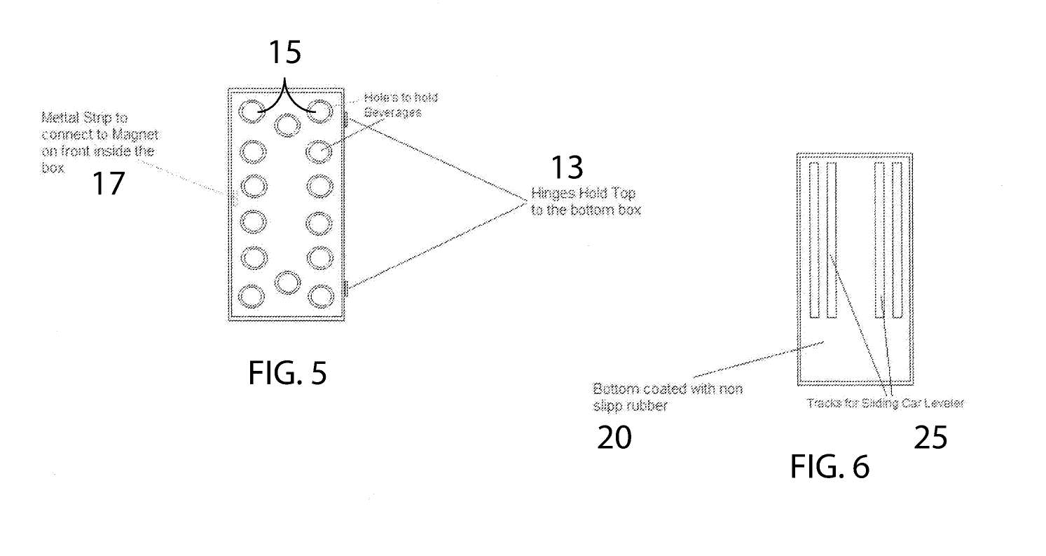

With reference to FIGS. 1-4, a preferred beverage carrier 100 is essentially a box with a top side 10 (having beverage support ports formed therein), bottom side 20, and at least one side wall 60. For a rectangular carrier, a back 50 and a front side 40 (partially open to show the interior of the carrier 100) would also be included. The interior is divided 30 into upper 33 and lower 37 regions, with the lower region 37 accessible though a drawer 45, door, or other port. The upper region 33 is accessible through the top side 10, which is hinged (FIG. 5). The interior of the upper region 33 is insulated 35 as this region is where beverages are stored. Insulation should be at least provided along the sides and possibly the bottom, and may be utilized to create temperature zones within the upper region for more customized temperature control. Heating and cooling packs may also be provided in such zones to further enhance this utility. Lower region 37 may also be insulated. Handles 65 may be provided on any side, such as side panels 60, for ease of carrying.

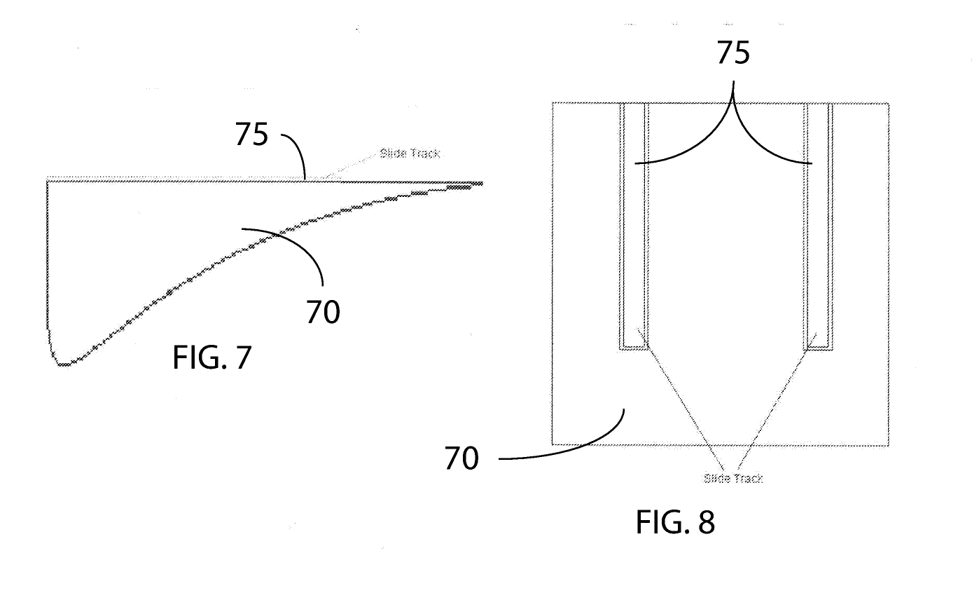

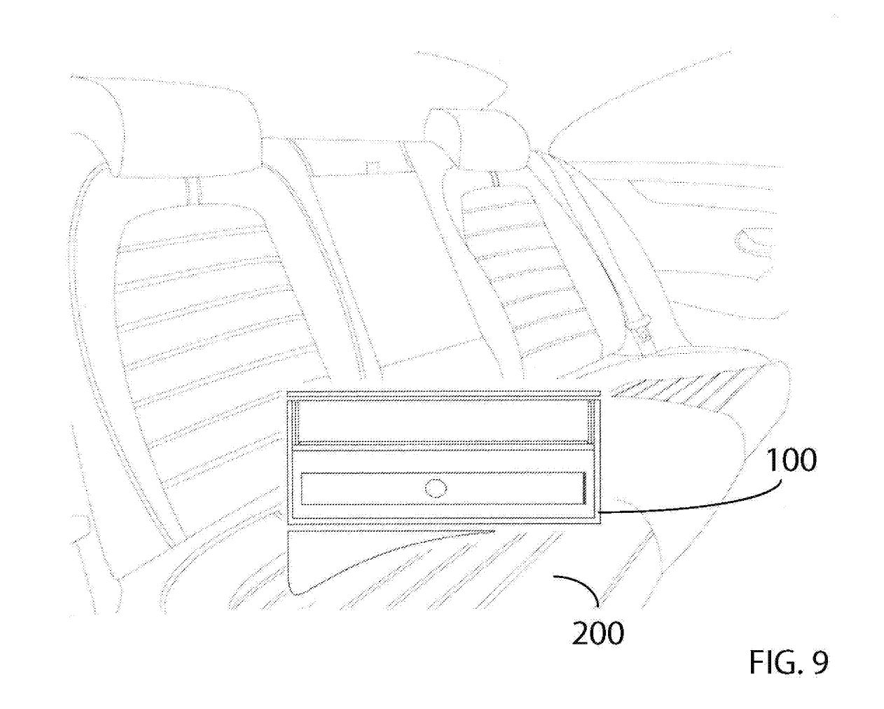

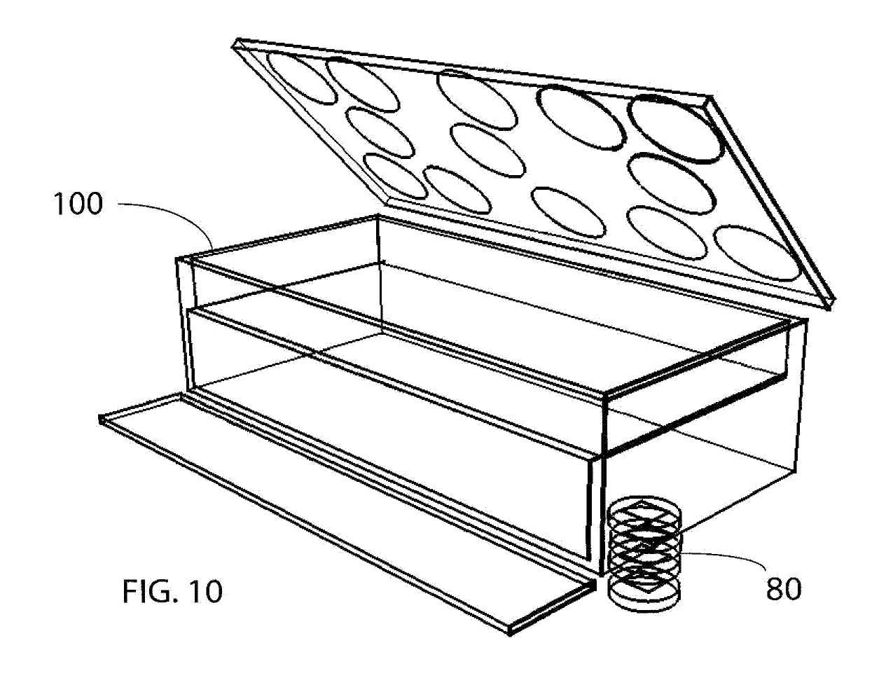

The bottom side 20 of the beverage carrier presents an attachment system for the optional car seat levelers such as module 70. In the depicted embodiment, the attachment system is a plurality of mating tracks 25, 75 (FIGS. 6 and 8) so that the car seat leveler module 70 may simply be slid into place. It should be noted that the recessed tracks 25 are depicted in the beverage carrier so as to allow the carrier 100 to sit on a flat surface. The leveler module 70 (FIGS. 7, 8) is essentially a block structure with a tapered, and possibly curved wedge. In use (FIG. 9) the car seat leveler module 70 is positioned with the thickest edge nestled in the back of the seat of the car 200, which is usually the lowest part of the seat. The taper then allows the beverages to remain level in the beverage carrier. It should be readily noted that different shapes of levelers may be manufactured so as to comport with different car seat styles and user adaptation.

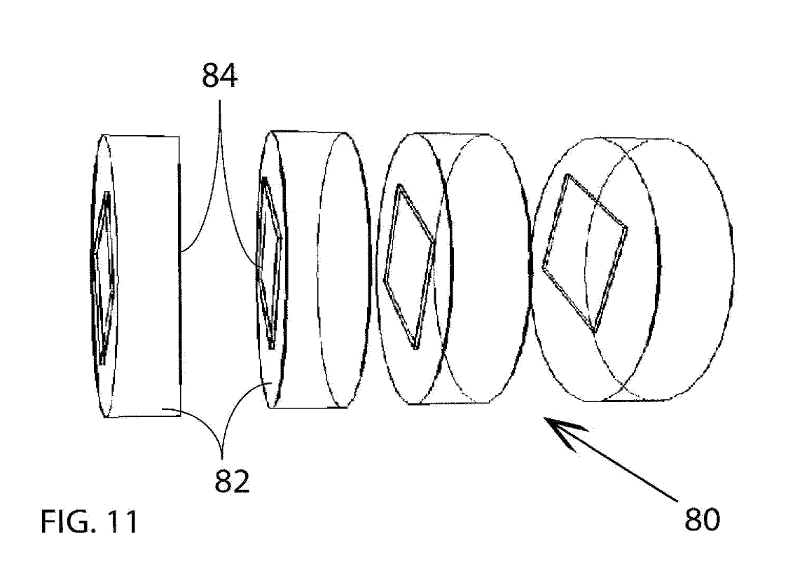

An alternate leveler construction (FIGS. 10 and 11) may be made by creating a tower of blocks 80. It should readily be appreciated that suitable blocks 82 may be formed from the waste after cutting the beverage support ports 15 in the carrier. These blocks 82 may then be affixed with a suitable attachment medium, such as hook-and-loop fastening tape 84 or magnets, and assembled together into a support column 80 of suitable size to accommodate the vehicle's seat. The column 80 may then be readily and selectively attached or detached by suitable means to the carrier 100.

The beverage carrier 100 may be made to any conceivable size or shape, including round, ovular, irregular, or polygonal, that would be humanly possible to carry with an ideal size being to fit within the confines of a car's front seat. As such, any number of ports 15 for holding beverages may be utilized. As cups tend to be standard sizes, ports 15 may be uniform. The beverage carrier 100 may be made of any suitable material, with wood and polymers preferred as they have inherent insulating properties.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A beverage carrier comprising:
a. a hollow carrier body having at least one side wall and a lid and bottom, divided into interior upper and interior lower sections;
b. the lid having a plurality of ports so as to secure at least one beverage;
c. the interior upper section being thermally insulated;
d. the interior lower section being accessible from an exterior of the beverage carrier; and
e. a leveling structure, attachable to the bottom of the beverage carrier.

2. The beverage carrier of claim 1, the bottom section also being thermally insulated.

3. The beverage carrier of 1, the leveling structure further comprising a plurality of blocks selectively attachable to each other and the bottom of the beverage carrier.

4. The beverage carrier of claim 1, the leveling structure comprising a wedge body attachable to the bottom of the beverage carrier.

5. The beverage carrier of claim 4, the leveling structure having a slidable interface with the bottom of the beverage carrier.
